(19) United States
(12) Patent Application Publication
(10) Pub. No.: US 2025/0068823 A1
(43) Pub. Date: Feb. 27, 2025

(54) CIRCUIT DESIGN MODELING FOR BONDING INTEGRATED CIRCUITS

(71) Applicant: Tokyo Electron Limited, Tokyo (JP)

(72) Inventors: Henry Jim Fulford, Marianna, FL (US); Partha Mukhopadhyay, Oviedo, FL (US); Zuriel CARIBE, Albany, NY (US); Anton deVilliers, Albany, NY (US)

(21) Appl. No.: 18/615,365

(22) Filed: Mar. 25, 2024

Related U.S. Application Data
(60) Provisional application No. 63/534,763, filed on Aug. 25, 2023.

(51) Int. Cl. G06F 30/398; G06F 30/392; G06F 113/18; G06F 119/02; G06F 119/08; H01L 23/00

(52) U.S. Cl. CPC G06F 30/398; G06F 30/392; H01L 24/08; G06F 2113/18; G06F 2119/02; G06F 2119/08; H01L 24/80; H01L 2224/08058; H01L 2224/08059; H01L 2224/0807; H01L 2224/08146; H01L 2224/80097; H01L 2224/80895; H01L 2224/80896; H01L 2224/80908; H01L 2924/3512

(57) ABSTRACT

A method includes receiving a first layout file for a first workpiece and a second layout file for a second workpiece. First layout file and second layout file are analyzed to identify contact points, which are grouped into bins. A contact point of a first bin is simulated using a simulation model. Contact point includes a first feature of the first workpiece and a second feature of the second workpiece. In response to determining that the contact point does not have desired properties, a first layout of the first feature and a second layout of the second feature are updated to determine an updated contact point. Updated contact point is simulated using the simulation model. In response to determining that the updated contact point has the desired properties, first layout file is updated to include updated first layout, and second layout file is updated to include updated second layout.

### CROSS-REFERENCE TO RELATED APPLICATIONS

This application claims the benefit of U.S. Provisional Application No. 63/534,763, filed on Aug. 25, 2023, which application is hereby incorporated herein by reference.

### TECHNICAL FIELD

The present disclosure relates generally to a system and method for microfabrication of integrated circuits, and, in particular embodiments, to a system and method for heterogeneous integration of integrated circuits.

### BACKGROUND

Transistors per unit area on a chip have been increasing in density over the decades. As two-dimensional (2D) space available for circuit elements begins to exhaust space available, chip fabrication moves to three-dimensional (3D) designs in which transistors and other circuit elements are stacked on top of each other. Monolithic integration includes forming transistors on top of each other on a single wafer (substrate). Heterogeneous integration includes bonding two or more wafers and/or dies together to form vertically stacked devices.

### SUMMARY

In accordance with an embodiment of the present disclosure, an apparatus includes a memory configured to store a simulation model and process parameters of a bonding process. The apparatus further includes a processor communicatively coupled to the memory. The processor is configured to receive a first layout file, first design rules, first parameter variations, and first material parameters for a first workpiece. The processor is further configured to receive a second layout file, second design rules, second parameter variations, and second material parameters for a second workpiece. The processor is further configured to analyze the first layout file and the second layout file to identify a plurality of contact points. Each contact point includes a feature of the first workpiece and a feature of the second workpiece. The processor is further configured to determine types of the plurality of contact points based on the first layout file and the second layout file and group the plurality of contact points into a plurality of bins. Each bin includes a subset of the plurality of contact points having a same type. The processor is further configured to simulate a first contact point of a first bin of the plurality of bins using the simulation model. The first contact point includes a first feature of the first workpiece and a second feature of the second workpiece. The processor is further configured to determine whether the first contact point has desired properties and, in response to determining that the first contact point does not have the desired properties update a first layout of the first feature and a second layout of the second feature to determine an updated first contact point, simulate the updated first contact point using the simulation model, and determine whether the updated first contact point has the desired properties. In response to determining that the updated first contact point has the desired properties, the processor is further configured to update the first layout file to include the updated first layout of the first feature and update the second layout file to include the updated second layout of the second feature.

In accordance with an embodiment of the present disclosure, a method includes receiving a first layout file, first design rules, first parameter variations, and first material parameters for a first workpiece, and receiving a second layout file, second design rules, second parameter variations, and second material parameters for a second workpiece. The method further includes analyzing the first layout file and the second layout file to identify a plurality of contact points. Each contact point includes a feature of the first workpiece and a feature of the second workpiece. The method further includes determining types of the plurality of contact points based on the first layout file and the second layout file and grouping the plurality of contact points into a plurality of bins. Each bin includes a subset of the plurality of contact points having a same type. The method further includes simulating a first contact point of a first bin of the plurality of bins using a simulation model. The first contact point includes a first feature of the first workpiece and a second feature of the second workpiece. The method further includes determining whether the first contact point has desired properties. In response to determining that the first contact point does not have the desired properties, the method further includes updating a first layout of the first feature and a second layout of the second feature to determine an updated first contact point, simulating the updated first contact point using the simulation model, and determining whether the updated first contact point has the desired properties. In response to determining that the updated first contact point has the desired properties, the method further includes updating the first layout file to include the updated first layout of the first feature and updating the second layout file to include the updated second layout of the second feature.

In accordance with an embodiment of the present disclosure, a non-transitory computer-readable medium storing instructions that, when executed by one or more processors, cause the one or more processors to receive a first layout file, first design rules, first parameter variations, and first material parameters for a first workpiece, and receive a second layout file, second design rules, second parameter variations, and second material parameters for a second workpiece. The instructions, when executed by one or more processors, further cause the one or more processors to analyze the first layout file and the second layout file to identify a plurality of contact points. Each contact point includes a feature of the first workpiece and a feature of the second workpiece. The instructions, when executed by one or more processors, further cause the one or more processors to determine types of the plurality of contact points based on the first layout file and the second layout file, group the plurality of contact points into a plurality of bins, wherein each bin includes a subset of the plurality of contact points having a same type, and simulate a first contact point of a first bin of the plurality of bins using a simulation model. The first contact point includes a first feature of the first workpiece and a second feature of the second workpiece. The instructions, when executed by one or more processors, further cause the one or more processors to determine whether the first contact point has desired properties. In response to determining that the first contact point does not have the desired properties, the instructions, when executed by one or more processors, further cause the one or more processors to update a first layout of the first feature and a second layout of the second feature to determine an updated first contact point, simulate the updated first contact point using the simulation model, and determine whether the updated first contact point has the desired properties. In response to determining that the updated first contact point has the desired properties, the instructions, when executed by one or more processors, further cause the one or more processors to update the first layout file to include the updated first layout of the first feature and update the second layout file to include the updated second layout of the second feature.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1A illustrates a schematic view of a bonding apparatus in accordance with various embodiments;

FIG. 1B illustrates a schematic view of a circuit design modeling system in accordance with various embodiments;

FIG. 2A illustrates perspective views of workpieces to be bonded in accordance with various embodiments;

FIG. 2B illustrates perspective views of workpieces to be bonded in accordance with various embodiments;

FIG. 3 illustrates a cross-sectional view of a workpiece in accordance with various embodiments;

FIGS. 4A and 4B illustrate top and cross-sectional views of bonding structures in accordance with various embodiments;

FIGS. 5A and 5B illustrate top and cross-sectional views of a bonding structure in accordance with various embodiments;

FIGS. 6A-6C illustrate cross-sectional views of a workpiece in accordance with various embodiments;

FIG. 7A illustrates a cross-sectional view of a workpiece stack in accordance with various embodiments;

FIG. 7B illustrates a cross-sectional view of a workpiece stack in accordance with various embodiments;

FIG. 7C illustrates a cross-sectional view of a workpiece stack in accordance with various embodiments;

FIG. 8 illustrates a cross-sectional view of a workpiece stack in accordance with various embodiments;

FIGS. 9A and 9B illustrate a process flow diagram of a method for circuit design modeling of workpieces to be bonded in accordance with various embodiments; and

FIGS. 10A and 10B illustrate a process flow diagram of a method for bonding workpieces in accordance with various embodiments.

### DETAILED DESCRIPTION OF ILLUSTRATIVE EMBODIMENTS

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope.

Because of the microscopic scale of circuit features, there are challenges with heterogeneous integration. For example, challenges include alignment and bonding of workpieces (e.g., wafers and/or dies). That is, correctly aligning bonding structures from one workpiece with corresponding bonding structures from another workpiece, and then making a reliable bond with opposing bonding structures in physical contact with each other.

Techniques disclosed herein include methods and systems for optimizing the design and process for heterogeneous integration (HI) bonding. Methods include software applications dedicated to optimizing the design and process for HI bonding. Such software application may include a physical model and an artificial intelligence (AI) model. The physical model includes thermal modeling (e.g., thermal expansion modelling, thermal conductivity modeling, thermal stress modeling, etc.), specifically targeting the bonding of top and bottom workpieces using bonding structures (e.g., copper vias), while considering metal layouts adjacent the bonding structures. The physical model considers various critical factors for a bonding structure, including a metal volume, insulation volume, metal isolation, metal density, insulation type, metal type, underlying metal line connected to the bonding structure, underlying via connected to the bonding structure, liner metal in the via, material type of the bonding structure, and shape of the bonding structure.

The physical model includes calculating a volume change of a metal of the bonding structure caused by thermal expansion during bonding. The physical model may predict the joining of bonding structures and identify any potential voids that may arise after the bonding process. The physical model further generates outputs indicating which bonding structures might encounter bonding issues during workpiece-to-workpiece bonding under specific bonding conditions, such as a bonding temperature, bonding time, and recess of bonding structure from an adjacent insulating film. For example, the physical model analyzes thermal stresses, identifying potential fracture or cracking risks of bonding structures, and predicts electrical and mechanical properties of the workpiece stack.

The software application may further include a chemical model. The chemical model may include analyzing interface effects, grain growth, and diffusion of copper into the surrounding insulator. By integrating these chemical analyses, the software application generates results enabling a more holistic understanding of the bonding process, leading to improved design decisions and optimization strategies.

The AI model may perform design checks, considering the 3D geometry and dimensions of the bonding structures involved. Should any problems be detected during the design check, the AI model can propose effective solutions to rectify the identified issues, ensuring an optimized and reliable workpiece-to-workpiece (e.g., die-to-wafer or wafer-to-wafer) bonding process.

The techniques described herein provide a simulation model that takes into consideration circuit architecture in combination with material specific properties, thermodynamic phenomena and process conditions to propose alternate architecture and process conditions to optimize heterogeneous integration processes. The model includes a physical model that determines if the different contact points between the first workpiece and the second workpiece will have desired properties with the given process inputs. When the contact point fails then the AI model reworks the layout for both the first workpiece and the second workpiece, then reruns the physical model. The AI model may also change process conditions of the bonding process as need if no layout solution can be obtained.

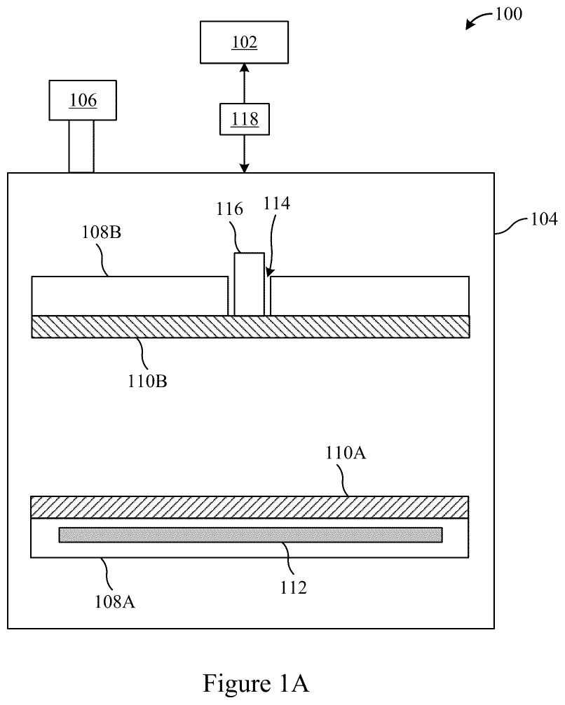

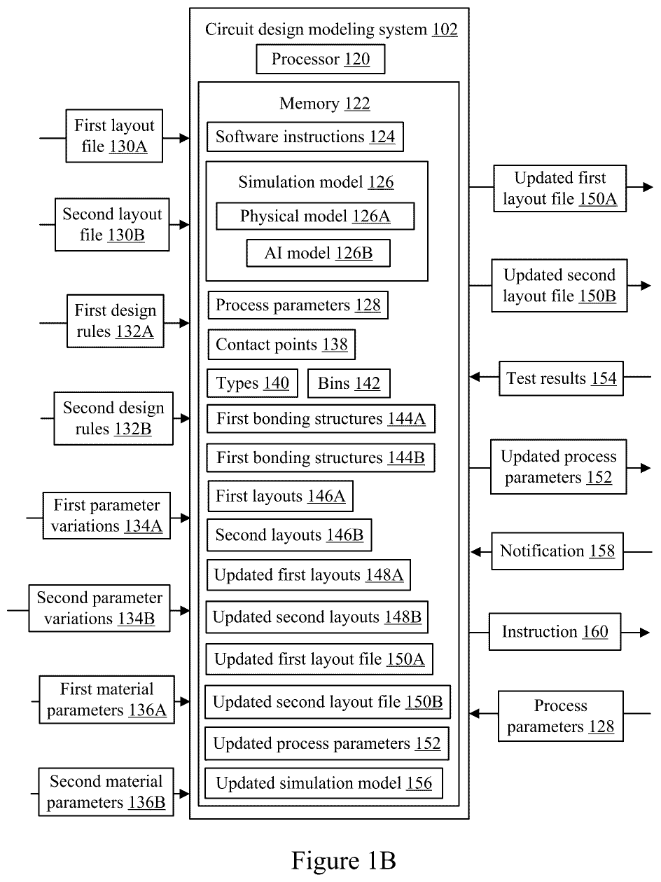

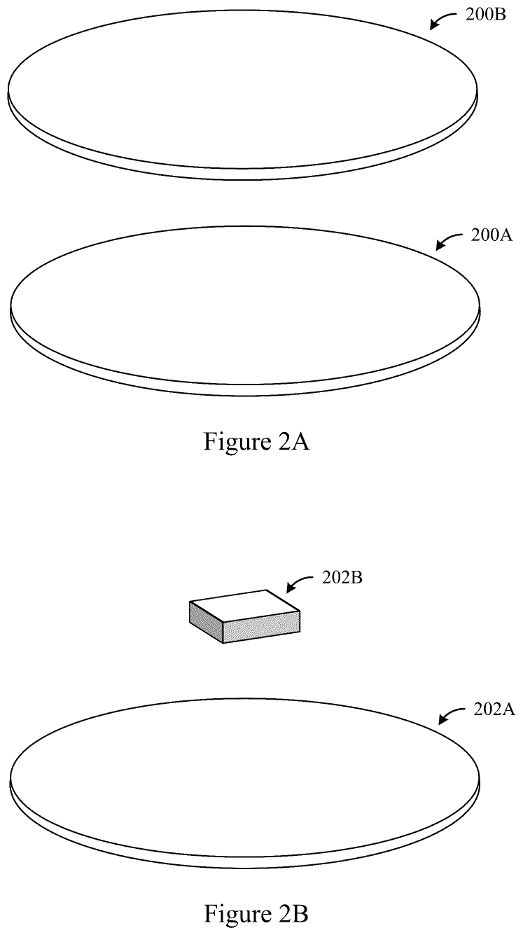

FIG. 1A illustrates a schematic view of a bonding apparatus 100 in accordance with various embodiments. The bonding apparatus 100 is configured to perform a bonding process to bond a first workpiece 110A to a second workpiece 110B. In some embodiments, the first workpiece 110A and the second workpiece 110B may be wafers as described below with reference to FIG. 2A. In such embodiments, the bonding apparatus 100 is configured to perform a wafer-to-wafer bonding process. In other embodiments, the first workpiece 110A may be a wafer and the second workpiece 110B may be a die as described below with reference to FIG. 2B. In such embodiments, the bonding apparatus 100 is configured to perform a die-to-wafer or chip-to-wafer bonding process.

The bonding apparatus 100 comprises a vacuum chamber 104 coupled to a pump 106. The pump 106 is configured to maintain a desired vacuum level within the vacuum chamber 104. In some embodiments, a first chuck 108A and a second chuck 108B is disposed in the vacuum chamber 104. The first chuck 108A is configured to hold the first workpiece 110A and the second chuck 108B is configured to hold the second workpiece 110B during the bonding process. The first chuck 108A and the second chuck 108B may comprise mechanical chucks, vacuum chucks, electrostatic chucks, or the like.

In some embodiments, the first chuck 108A is configured to move the first workpiece 110A toward the second workpiece 110B. The first chuck 108A may comprise a heating element 112. The heating element 112 is configured to heat the first workpiece 110A and the second workpiece 110B during the bonding process. The heating element 112 may be a resistive heating element, a hot plate, or the like. In some embodiments, the second chuck 108B is configured to move the second workpiece 110B toward the first workpiece 110A. The second chuck 108B may be an annular structure having an opening 114 therein. The opening 114 may be disposed at the center of the second chuck 108B. The second chuck 108B may further comprise a pin 116 within the opening 114. The pin 116 may be configured to extend into the opening 114 toward the second workpiece 110B, physically contact the second workpiece 110B, and bend the second workpiece 110B.

In some embodiments, the bonding apparatus 100 may comprise a circuit design modeling system 102. The circuit design modeling system 102 may be in signal communication with various components of the bonding apparatus 100. The circuit design modeling system 102 may exchange signals 118 with various components of the bonding apparatus 100. In some embodiments, the circuit design modeling system 102 may be configured to analyze layouts of the first workpiece 110A and the second workpiece 110B and update layouts of the first workpiece 110A and the second workpiece 110B such that a workpiece stack (e.g., comprising the first workpiece 110A and the second workpiece 110B) has desired properties. In other embodiments, the circuit design modeling system 102 may be configured to control operations of the bonding apparatus 100. In other embodiments, the circuit design modeling system 102 may be an external system separate from the bonding apparatus 100.

In operation, the bonding apparatus 100 is configured to move the first workpiece 110A toward the second workpiece 110B. After a desired distance between the first workpiece 110A and the second workpiece 110B is achieved, the pin 116 is extended toward the second workpiece 110B to bend the second workpiece 110B such that the second workpiece 110B makes a physical contact with the first workpiece 110A initiating a bonding process. After initiating the bonding process, the second workpiece 110B is released from the second chuck 108B to complete the bonding process to form workpiece stack comprising the first workpiece 110A and the second workpiece 110B. In some embodiments, after releasing the second workpiece 110B from the second chuck 108B, a bonding wave propagates from the centers of the first workpiece 110A and the second workpiece 110B toward edges of the first workpiece 110A and the second workpiece 110B.

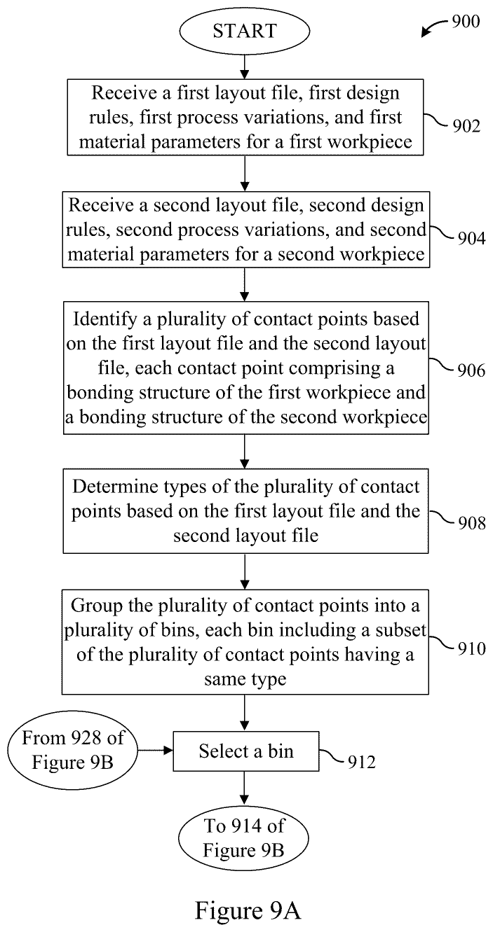

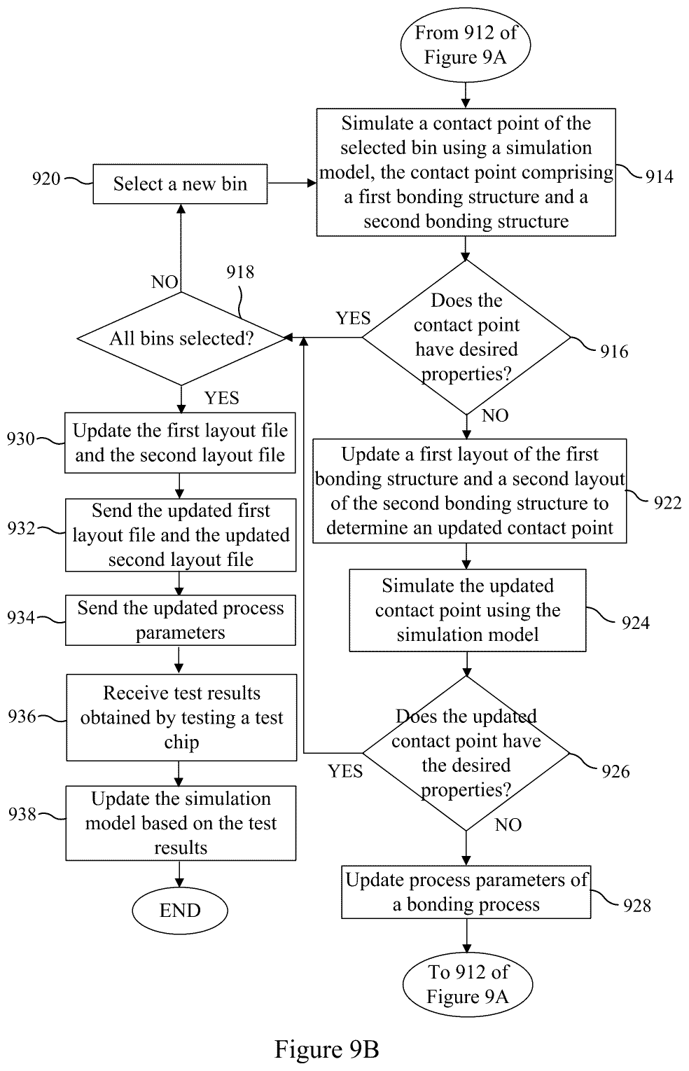

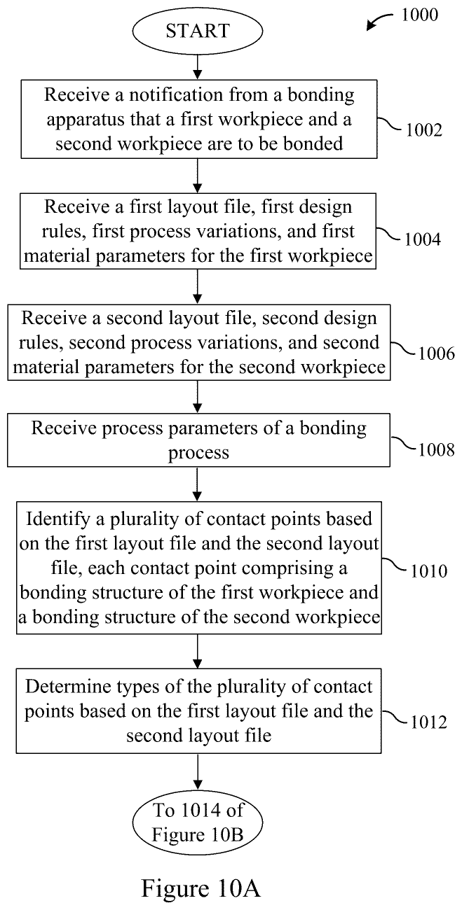

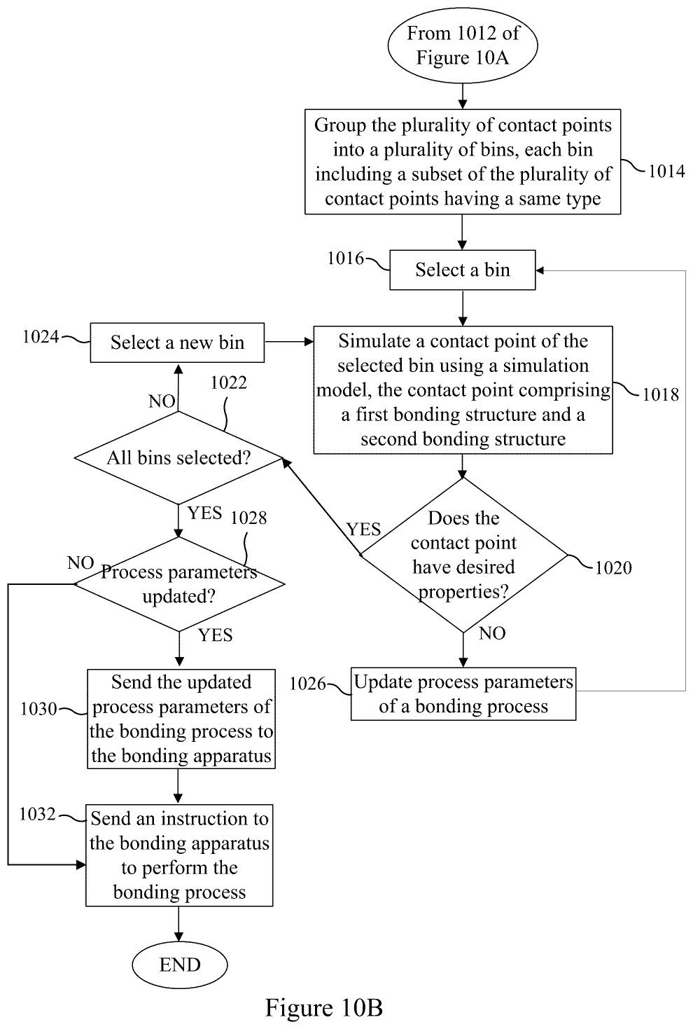

FIG. 1B illustrates a schematic view of the circuit design modeling system 102 in accordance with various embodiments. The circuit design modeling system 102 may comprise a processor 120 communicatively (or operably) coupled to a memory 122. The processor 120 may comprise one or more microprocessors having integrated circuits. The memory 122 may comprise a non-transitory computer-readable medium that is configured to store software instructions 124 and/or any other data. The software instructions 124, when executed by the processor 120, cause the processor 120 to perform various functions of the circuit design modeling system 102 described herein. The memory 122 may further store a simulation model 126. The simulation model 126 may comprise a physical model 126A and an AI model 126B. The physical model 126A, when executed by the processor 120, causes the processor 120 to simulate a bonding process of workpieces (e.g., first workpiece 110A and second workpiece 110B of FIG. 1A). The AI model 126B, when executed by the processor 120, causes the processor 120 to analyze results of the physical model 126A and generate updated layouts of the workpieces (e.g., first workpiece 110A and second workpiece 110B of FIG. 1A). In some embodiments, the circuit design modeling system 102 is configured to perform a method 900 for circuit design modeling of workpieces (e.g., first workpiece 110A and second workpiece 110B of FIG. 1A) to be bonded as described below with reference to FIGS. 9A and 9B. In other embodiments, the circuit design modeling system 102 may perform one or more operations of a method 1000 for bonding workpieces (e.g., first workpiece 110A and second workpiece 110B of FIG. 1A) as described below with reference to FIGS. 10A and 10B.

FIG. 2A illustrates perspective views of workpieces (e.g., workpieces 200A and 200B) to be bonded by the bonding apparatus 100 (see FIG. 1A) in accordance with various embodiments. For example, the workpiece 200A may be implemented as the first workpiece 110A and the workpiece 200B may be implemented as the second workpiece 110B. In the illustrated embodiment, the workpieces 200A and 200B are wafers. Each of the workpieces 200A and 200B may comprise a substrate. In some embodiments, the substrate may comprise a plurality of device regions. In such embodiments, the substrate may include isolation regions such as shallow trench isolation (STI) regions, diffusion regions, as well as other regions formed therein.

The substrate may comprise layers of semiconductors suitable for various microelectronics. In one or more embodiments, the substrate may be a silicon wafer, or a silicon-on-insulator (SOI) wafer. In certain embodiments, the substrate may comprise a silicon germanium wafer, silicon carbide wafer, gallium arsenide wafer, gallium nitride wafer, or other compound semiconductors. In other embodiments, the substrate may comprise heterogeneous layers such as silicon germanium on silicon, gallium nitride on silicon, silicon carbon on silicon, or layers of silicon on a silicon or SOI substrate.

Each of the workpieces 200A and 200B may further comprise an interconnect structure on a front side of the substrate. The interconnect structure may comprise one or more dielectric layers and one or more metallization layers within the one or more dielectric layers. In some embodiments, the one or more dielectric layers may comprise one or more suitable dielectric materials such as silicon oxide, low-k dielectric materials, or the like. The one or more metallization layers may comprise a plurality of conductive lines and a plurality of conductive vias electrically coupling adjacent metallization layers. The metallization layers may comprise a suitable conductive material such as copper (Cu), for example. The metallization layers may be formed by a damascene process, a dual damascene process, or the like.

Each of the workpieces 200A and 200B may further comprise one or more bonding structures. In some embodiments, the one or more bonding structures may be formed on the front side of the substrate over the interconnect structure. In some embodiments, portions of the topmost metallization layer of the interconnect structure act as bonding structure. In other embodiments, the one or more bonding structures may be formed on the backside of the substrate. In yet other embodiments, the one or more bonding structures may be formed both on the front side and the backside of the substrate. The one or more bonding structures may be configured to electrically and mechanically couple the bonded workpieces. The one or more bonding structures may comprise a suitable conductive material such as copper (Cu), for example. In some embodiments, the workpieces 200A and 200B may have similar structures and be formed using similar process steps. In other embodiments, the workpiece 200A may be different from the workpiece 200B, such that they may comprise different structures and may be formed using different process steps.

FIG. 2B illustrates perspective views of workpieces (e.g., workpieces 202A and 202B) to be bonded by the bonding apparatus 100 (see FIG. 1A) in accordance with various embodiments. For example, the workpiece 202A may be implemented as the first workpiece 110A and the workpiece 202B may be implemented as the second workpiece 110B. In the illustrated embodiment, the workpiece 202A is a wafer and the workpiece 202B is a die. The workpiece 202A may be similar to the workpiece 200A (see FIG. 2A) and the description is not repeated herein. The workpiece 202B may be formed as a wafer and subsequently diced into a plurality of dies. The wafer may be similar to the workpiece 200A (see FIG. 2A) and the description is not repeated herein.

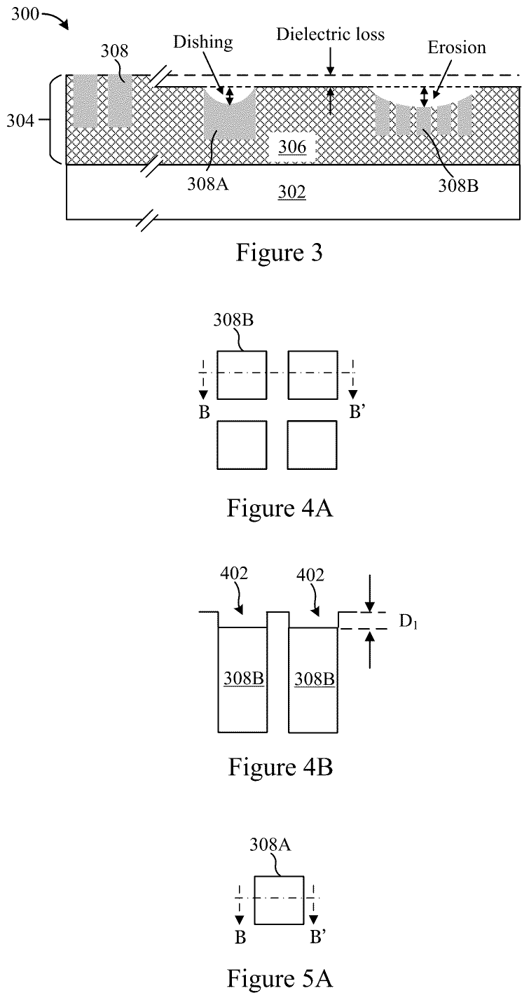

FIG. 3 illustrates a cross-sectional view of a workpiece 300 in accordance with various embodiments. The workpiece 300 may be implemented as the first workpiece 110A or the second workpiece 110B (see FIG. 1A). The workpiece 300 comprises a substrate 302. The substrate 302 may be similar to the substrate of the workpiece 200A (see FIG. 2A) and the description is not repeated herein. The workpiece 300 may further comprise an interconnect structure (not shown) on a front side of the substrate 302. The interconnect structure may comprise one or more dielectric layers and one or more metallization layers within the one or more dielectric layers. In some embodiments, the one or more dielectric layers may comprise one or more suitable dielectric materials such as silicon oxide, low-k dielectric materials, or the like. The one or more metallization layers may comprise a plurality of conductive lines and a plurality of conductive vias electrically coupling adjacent metallization layers. The metallization layers may comprise a suitable conductive material such as copper (Cu), for example. The metallization layers may be formed by a damascene process, a dual damascene process, or the like.

The workpiece 300 may further comprise a bonding layer 304 over the interconnect structure. The bonding layer 304 may comprise a dielectric layer 306 and a plurality of bonding structures 308 in the dielectric layer 306. The dielectric layer 306 may comprise a suitable dielectric material such as silicon oxide, for example. The bonding structures 308 may comprise a suitable conductive material such as copper (Cu), for example. In some embodiments, the bonding structures 308 have different dimensions and pitches within the dielectric layer 306. A chemical mechanical polishing (CMP) process may be performed on the workpiece 300 to planarize the bonding layer 304 and expose the bonding structures 308. The CMP process may cause erosion of the dielectric layer 306 and dishing of the bonding structures 308. Due to variations of dimensions and pitches of the bonding structures 308, amounts of erosion and dishing also vary along the workpiece 300. For example, isolated bonding structures 308A are subject to a greater dishing than densely-spaced bonding structures 308B.

FIGS. 4A and 4B illustrate top and cross-sectional views of bonding structures 308B (see FIG. 3) in accordance with various embodiments. In particular, FIG. 4A illustrates a top view and FIG. 4B illustrates a cross-sectional view along a lone BB′ of FIG. 4A. In the illustrated embodiment, the bonding structures 308B are densely-spaced bonding structures. Due to dishing, the bonding structures 308B are recessed below a top surface of the workpiece 300 (see FIG. 3). In some embodiments, recesses 402 over the bonding structures 308B may have a depth D₁ in a range from 0 nm to 20 nm. In other embodiments, the depth D₁ may be in a range from 3 nm to 8 nm.

FIGS. 5A and 5B illustrate top and cross-sectional views of the bonding structure 308A (see FIG. 3) in accordance with various embodiments. In particular, FIG. 5A illustrates a top view and FIG. 5B illustrates a cross-sectional view along a lone BB′ of FIG. 5A. In the illustrated embodiment, the bonding structure 308A is an isolated bonding structure. Due to dishing, the bonding structure 308A is recessed below the top surface of the workpiece 300 (see FIG. 3). In some embodiments, a recess 502 over the bonding structure 308A may have a depth D₂ in a range from 0 nm to 20 nm. In other embodiments, the depth D₂ may be in a range from 3 nm to 8 nm. In the illustrated embodiment, the depth D₂ is greater than the depth D₁.

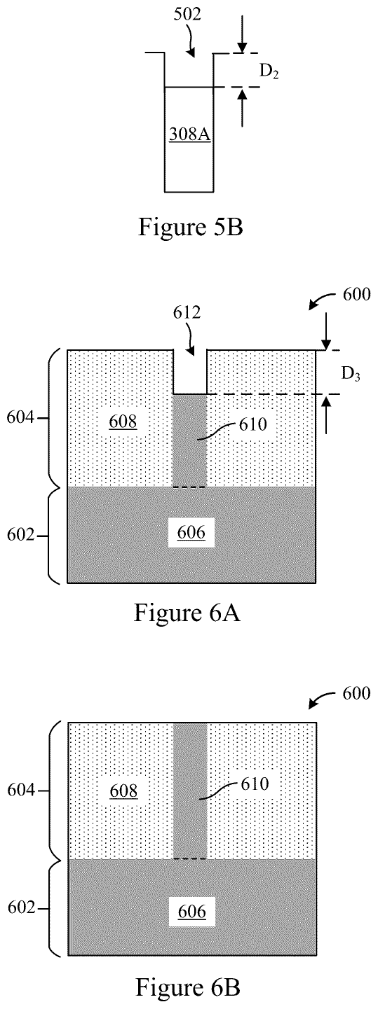

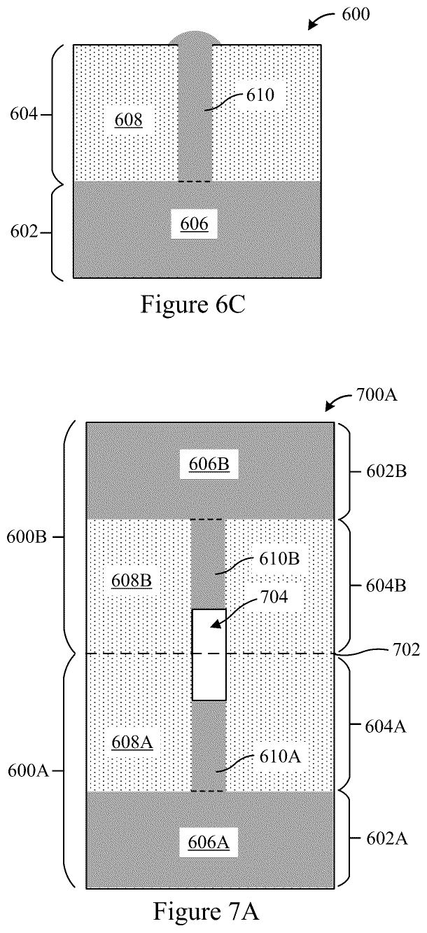

FIG. 6A illustrates a cross-sectional view of a portion of a workpiece 600 in accordance with various embodiments. In particular, FIG. 6A illustrates a metallization layer 602 and a bonding layer 604 of the workpiece 600 at a first temperature. In some embodiments, the first temperature may be less than a bonding temperature. In some embodiments, the workpiece 600 is similar to the workpiece 200A (see FIG. 2A) and the description is not repeated herein. In some embodiments, the metallization layer 602 may be a topmost metallization layer of the workpiece 600. The metallization layer 602 may comprise a suitable conductive material such as copper (Cu), for example. The bonding layer 604 may comprise a dielectric layer 608 and a bonding structure 610 in the dielectric layer 608. The dielectric layer 608 may comprise a suitable dielectric material such as silicon oxide, for example. The bonding structure 610 may be in physical and electrical contact with a metal line 606 of the metallization layer 602. The bonding structure 610 may comprise a suitable conductive material such as copper (Cu), for example. The bonding structure 610 may be recessed below a top surface of the workpiece 600 due to dishing, for example. In some embodiments, the recess 612 has a depth D₃ in a range from 0 nm to 20 nm. In other embodiments, the depth D₃ may be in a range from 3 nm to 8 nm. implement the physical model 126A to simulate thermal processes (e.g., thermal expansion, thermal conductively, thermal stress, etc.) of the workpiece 600. For example, the physical model 126A may analyze thermal expansions of the bonding structure 610 and the metal line 606 to determine whether a material of the bonding structure 610 and the metal line 606 fills the recess 612. In the illustrated embodiment, the physical model 126A may determine that the material of the bonding structure 610 and the metal line 606 dose not fill the recess 612 at the first temperature.

FIG. 6B illustrates a cross-sectional view of a portion of the workpiece 600 in accordance with various embodiments. In particular, FIG. 6B illustrates the metallization layer 602 and the bonding layer 604 of the workpiece 600 at a second temperature greater than the first temperature. The second temperature may equal to a bonding temperature. In some embodiments, the circuit design modeling system 102 (see FIG. 1B) may implement the physical model 126A to simulate thermal processes (e.g., thermal expansion, thermal conductively, thermal stress, etc.) of the workpiece 600. For example, the physical model 126A may analyze thermal expansions of the bonding structure 610 and the metal line 606 to determine whether a material of the bonding structure 610 and the metal line 606 fills the recess 612. In the illustrated embodiment, the physical model 126A may determine that the material of the bonding structure 610 and the metal line 606 fills the recess 612 (see FIG. 6A) at the second temperature.

FIG. 6C illustrates a cross-sectional view of a portion of the workpiece 600 in accordance with various embodiments. In particular, FIG. 6B illustrates the metallization layer 602 and the bonding layer 604 of the workpiece 600 at a third temperature greater than the first temperature and the second temperature. The third temperature may equal to a bonding temperature. In some embodiments, the circuit design modeling system 102 (see FIG. 1B) may implement the physical model 126A to simulate thermal processes (e.g., thermal expansion, thermal conductively, thermal stress, etc.) of the workpiece 600. For example, the physical model 126A may analyze thermal expansions of the bonding structure 610 and the metal line 606 to determine whether a material of the bonding structure 610 and the metal line 606 fills the recess 612. In the illustrated embodiment, the physical model 126A may determine that the material of the bonding structure 610 and the metal line 606 overfills the recess 612 (see FIG. 6A) at the second temperature.

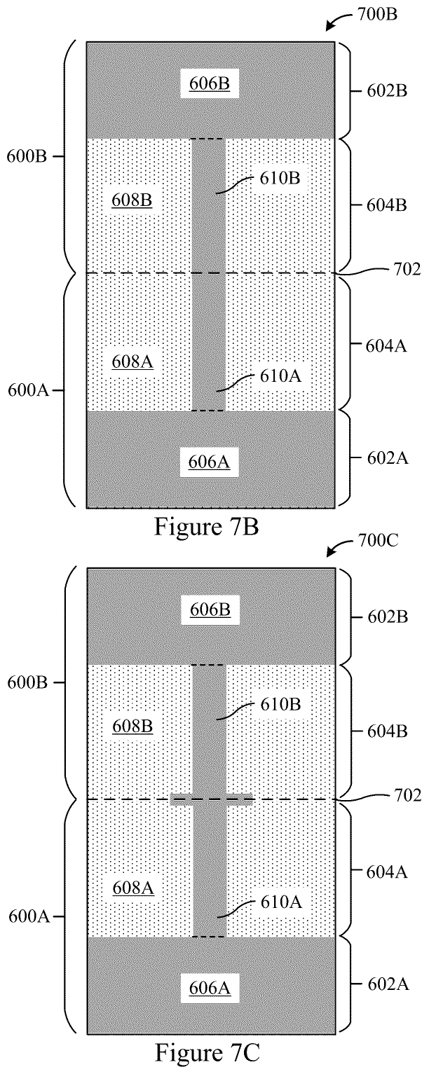

FIG. 7A illustrates a cross-sectional view of a workpiece stack 700A in accordance with various embodiments. The workpiece stack 700A comprises a first workpiece 600A bonded to a second workpiece 600B. The first workpiece 600A and the second workpiece 600B may be similar to the workpiece 600 (see FIG. 6A), with similar features being labeled by similar numerical references, and descriptions of similar features are not repeated herein. In some embodiments, the circuit design modeling system 102 (see FIG. 1B) may implement the physical model 126A to simulate thermal processes (e.g., thermal expansion, thermal conductively, thermal stress, etc.) of the workpiece stack 700A during the bonding process at a first bonding temperature. In the illustrated embodiment, the first bonding temperature equals to the first temperature of the workpiece 600 shown in FIG. 6A. The physical model 126A may analyze thermal expansions of the bonding structures 610A and 610B and the metal lines 606A and 606B to determine whether a material of the bonding structures 610A and 610B and the metal lines 606A and 606B fills the recesses formed due to dishing. In the illustrated embodiment, the physical model 126A may determine that the material of the bonding structure 610A and 610B and the metal lines 606A and 606B does not fill the recesses at the first bonding temperature.

The physical model 126A may determine that the bonding layer 604A of the first workpiece 600A is bonded to the bonding layer 604B of the second workpiece 600B such that the dielectric layer 608A is bonded to the dielectric layer 608B, with a bonding interface 702 indicated by a dashed line. The physical model 126A may further determine that the bonding structures 610A and 610B do not fill respective recesses at the first bonding temperature and are not bonded to each other. Accordingly, the bonding structures 610A and 610B fail to electrically couple the metal line 606A of the metallization layer 602A of the first workpiece 600A to a metal line 606B of a metallization layer 602B of the second workpiece 600B. In such embodiments, the workpiece stack 700A comprises a void 704 at the bonding interface 702. The bonded structure of the bonding structures 610A and 610B may be also referred to as a contact point. In the illustrated embodiments, the contact point fails to electrically couple the first workpiece 600A to the second workpiece 600B. In some embodiments, the AI model 126B may generate updated layouts (e.g., comprising updated widths, lengths, and/or heights) for the bonding structures 610A and 610B and/or the metal lines 606A and 606B, such that the formation of the void 704 is avoided.

FIG. 7B illustrates a cross-sectional view of a workpiece stack 700B in accordance with various embodiments. The workpiece stack 700B comprises a first workpiece 600A bonded to a second workpiece 600B. The first workpiece 600A and the second workpiece 600B may be similar to the workpiece 600 (see FIG. 6A), with similar features being labeled by similar numerical references, and descriptions of similar features are not repeated herein. In some embodiments, the circuit design modeling system 102 (see FIG. 1B) may implement the physical model 126A to simulate thermal processes (e.g., thermal expansion, thermal conductively, thermal stress, etc.) of the workpiece stack 700B during the bonding process at a second bonding temperature. In the illustrated embodiment, the second bonding temperature equals to the second temperature of the workpiece 600 shown in FIG. 6B. The physical model 126A may analyze thermal expansions of the bonding structures 610A and 610B and the metal lines 606A and 606B to determine whether a material of the bonding structures 610A and 610B and the metal lines 606A and 606B fills the recesses formed due to dishing. In the illustrated embodiment, the physical model 126A may determine that the material of the bonding structure 610A and 610B and the metal lines 606A and 606B fills the recesses at the second bonding temperature.

The physical model 126A may determine that the bonding layer 604A of the first workpiece 600A is bonded to the bonding layer 604B of the second workpiece 600B such that the dielectric layer 608A is bonded to the dielectric layer 608B, with a bonding interface 702 indicated by a dashed line. The physical model 126A may further determine that the bonding structures 610A and 610B fill respective recesses at the second bonding temperature and are bonded to each other. Accordingly, the bonding structures 610A and 610B electrically couple the metal line 606A of the metallization layer 602A of the first workpiece 600A to the metal line 606B of the metallization layer 602B of the second workpiece 600B. The bonded structure of the bonding structures 610A and 610B may be also referred to as a contact point. Accordingly, the contact point (comprising the bonding structures 610A and 610B) electrically couples the metal line 606A of the metallization layer 602A of the first workpiece 600A to the metal line 606B of the metallization layer 602B of the second workpiece 600B. In some embodiments, the AI model 126B may determine that layout updates for the bonding structures 610A and 610B and/or the metal lines 606A and 606B are not needed.

FIG. 7C illustrates a cross-sectional view of a workpiece stack 700C in accordance with various embodiments. The workpiece stack 700C comprises a first workpiece 600A bonded to a second workpiece 600B. The first workpiece 600A and the second workpiece 600B may be similar to the workpiece 600 (see FIG. 6A), with similar features being labeled by similar numerical references, and descriptions of similar features are not repeated herein. In some embodiments, the circuit design modeling system 102 (see FIG. 1B) may implement the physical model 126A to simulate thermal processes (e.g., thermal expansion, thermal conductively, thermal stress, etc.) of the workpiece stack 700C during the bonding process at a third bonding temperature. In the illustrated embodiment, the third bonding temperature equals to the third temperature of the workpiece 600 shown in FIG. 6C. The physical model 126A may analyze thermal expansions of the bonding structures 610A and 610B and the metal lines 606A and 606B to determine whether a material of the bonding structures 610A and 610B and the metal lines 606A and 606B fills the recesses formed due to dishing. In the illustrated embodiment, the physical model 126A may determine that the material of the bonding structure 610A and 610B and the metal lines 606A and 606B over fills the recesses at the third bonding temperature.

The physical model 126A may determine that the bonding layer 604A of the first workpiece 600A is bonded to the bonding layer 604B of the second workpiece 600B such that the dielectric layer 608A is bonded to the dielectric layer 608B, with a bonding interface 702 indicated by a dashed line. The physical model 126A may further determine that the bonding structures 610A and 610B overfill respective recesses at the third bonding temperature such that the material of the bonding structures 610A and 610B extends along the bonding interface 702. The bonded structure of the bonding structures 610A and 610B may be also referred to as a contact point. Accordingly, the contact point (comprising the bonding structures 610A and 610B) electrically couples the metal line 606A of the metallization layer 602A of the first workpiece 600A to the metal line 606B of the metallization layer 602B of the second workpiece 600B. In some embodiments, the material of the bonding structures 610A and 610B that extends along the bonding interface 702 adversely affects properties of the contact point. In some embodiments, the AI model 126B may generate updated layouts (e.g., comprising updated widths, lengths, and/or heights) for the bonding structures 610A and 610B and/or the metal lines 606A and 606B, such that the material of the bonding structures 610A and 610B does not extends along the bonding interface 702 at the third bonding temperature.

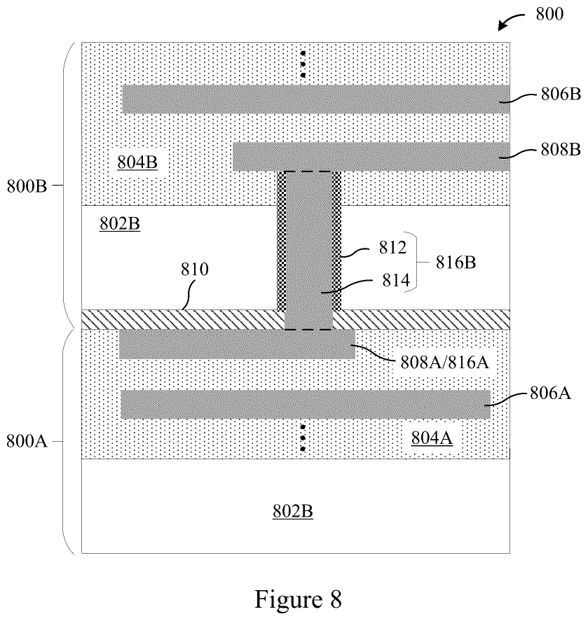

FIG. 8 illustrates a cross-sectional view of a workpiece stack 800 in accordance with various embodiments. The workpiece stack 800 comprises a first workpiece 800A bonded to a second workpiece 800B. In the illustrated embodiment, a front side of the first workpiece 800A is bonded to a back side of the second workpiece 800B. The first workpiece 800A comprises a substrate 802A and an interconnect structure on a front side of the substrate 802A. In some embodiments, the substrate 802A may be similar to the substrate of the workpiece 200A (see FIG. 2A) and the description is not repeated herein. The interconnect structure may comprise one or more dielectric layers 804A and one or more metallization layers (e.g., metallization layers 806A and 808A) within the one or more dielectric layers 804A. In some embodiments, the one or more dielectric layers 804A may comprise one or more suitable dielectric materials such as silicon oxide, low-k dielectric materials, or the like. The one or more metallization layers (e.g., metallization layers 806A and 808A) may comprise a plurality of conductive lines and a plurality of conductive vias electrically coupling adjacent metallization layers. The metallization layers may comprise a suitable conductive material such as copper (Cu), for example. The metallization layers may be formed by a damascene process, a dual damascene process, or the like. In some embodiments, portions of the topmost metallization layer (e.g., metallization layer 808A) may act as a bonding structure 816A.

The second workpiece 800B comprises a substrate 802B and an interconnect structure on a front side of the substrate 802B. In some embodiments, the substrate 802B may be similar to the substrate of the workpiece 200A (see FIG. 2A) and the description is not repeated herein. The interconnect structure may comprise one or more dielectric layers 804B and one or more metallization layers (e.g., metallization layers 806B and 808B) within the one or more dielectric layers 804B. In some embodiments, the one or more dielectric layers 804B may comprise one or more suitable dielectric materials such as silicon oxide, low-k dielectric materials, or the like. The one or more metallization layers (e.g., metallization layers 806B and 808B) may comprise a plurality of conductive lines and a plurality of conductive vias electrically coupling adjacent metallization layers. The metallization layers may comprise a suitable conductive material such as copper (Cu), for example. The metallization layers may be formed by a damascene process, a dual damascene process, or the like.

In some embodiments, the second workpiece 800B further comprises a through-silicon via (TSV) 816B extending through the substrate 802B and in physical and electrical contact with metallization layer 808B. The TSV 816B may comprises a conductive material 814 and a dielectric liner 812 isolating the conductive material 814 from the substrate 802B. The conductive material 814 may comprise a suitable metallic material such as copper (Cu), for example. The dielectric liner 812 may comprise a suitable dielectric material such as silicon oxide, silicon nitride, a combination thereof, or the like. In some embodiments, TSV 816B may act as a bonding structure. In some embodiments, the second workpiece 800B may further comprise a dielectric layer 810 on the back side of the substrate 802B. The dielectric layer 810 may comprise a suitable dielectric material such as silicon oxide, silicon nitride, a combination thereof, or the like.

In some embodiments, the circuit design modeling system 102 (see. FIG. 1B) may implement the physical model 126A to simulate thermal processes (e.g., thermal expansion, thermal conductively, thermal stress, etc.) of the workpiece stack 800 during the bonding process. The physical model 126A may analyze the bonding structure 816A and the TSV 816B to determine if a contact point formed after bonding the bonding structure 816A to the TSV 816B has desired properties. In some embodiments, the AI model 126B may analyze results of the physical model 126A to determine whether updated layouts (e.g., comprising updated widths, lengths, and/or heights) for the bonding structure 816A and the TSV 816B are needed. In some embodiments, the first workpiece 800A and the second workpiece 800B may be bonded using the bonding apparatus 100 (see FIG. 1A) such that a topmost dielectric layer of the one or more dielectric layers 804A is bonded to the dielectric layer 810 and the bonding structure 816A is bonded to the TSV 816B.

FIGS. 9A and 9B illustrate a process flow diagram of a method 900 for circuit design modeling of workpieces to be bonded in accordance with various embodiments. The method 900 may be implemented by the circuit design modeling system 102 of FIG. 1B. The method 900 may be implemented, at least in part, in the form of executable code (e.g., software instructions 124 and simulation model 126 of FIG. 1B) stored on non-transitory, tangible, computer-readable medium (e.g., memory 122 of FIG. 1B) that when executed by one or more processors (e.g., processor 120 of FIG. 1B) may cause the one or more processors to perform one or more of the operations 902-938.

Method 900 starts with operation 902. In operation 902, a processor 120 of the circuit design modeling system 102 (see FIG. 1B) receives a first layout file (e.g., first layout file 130A of FIG. 1B), first design rules (e.g., first design rules 132A of FIG. 1B), first parameter variations (e.g., first parameter variations 134A of FIG. 1B), and first material parameters (e.g., first material parameters 136A of FIG. 1B) for a first workpiece (e.g., first workpiece 110A of FIG. 1A). In operation 904, the processor 120 of the circuit design modeling system 102 receives a second layout file (e.g., second layout file 130B of FIG. 1B), second design rules (e.g., second design rules 132B of FIG. 1B), second parameter variations (e.g., second parameter variations 134B of FIG. 1B), and second material parameters (e.g., second material parameters 136B of FIG. 1B) for a second workpiece (e.g., second workpiece 110B of FIG. 1A).

The first layout file (e.g., first layout file 130A of FIG. 1B) and the second layout file (e.g., second layout file 130B of FIG. 1B) may include geometries and dimensions of bonding structures of the first workpiece (e.g., first workpiece 110A of FIG. 1A) and the second workpiece (e.g., second workpiece 110B of FIG. 1A), respectively. The first layout file (e.g., first layout file 130A of FIG. 1B) and the second layout file (e.g., second layout file 130B of FIG. 1B) may further include geometries and dimensions of metallization layers adjacent to the bonding structures. The first design rules (e.g., first design rules 132A of FIG. 1B) and the second design rules (e.g., second design rules 132B of FIG. 1B) include design rules for the first workpiece (e.g., first workpiece 110A of FIG. 1A) and the second workpiece (e.g., second workpiece 110B of FIG. 1A), respectively. The first material parameters (e.g., first material parameters 136A of FIG. 1B) and the second material parameters (e.g., second material parameters 136B of FIG. 1B) include information about the materials used, along with their thermal, mechanical, and electrical properties for the first workpiece (e.g., first workpiece 110A of FIG. 1A) and the second workpiece (e.g., second workpiece 110B of FIG. 1A), respectively. The first parameter variations (e.g., first parameter variations 134A of FIG. 1B) and second parameter variations (e.g., second parameter variations 134B of FIG. 1B) include ranges of dimensions of various structures (e.g., widths, lengths, and recess depths of bonding structures) due to process variations while forming the first workpiece (e.g., first workpiece 110A of FIG. 1A) and the second workpiece (e.g., second workpiece 110B of FIG. 1A), respectively.

In operation 906, the processor 120 of the circuit design modeling system 102 analysis the first layout file (e.g., first layout file 130A of FIG. 1B) and the second layout file (e.g., second layout file 130B of FIG. 1B) to identify a plurality of contact points (e.g., contact points 138 of FIG. 1B). Each contact point (e.g., each of contact points 138 of FIG. 1B) comprises a bonding structure (e.g., bonding structure 144A of FIG. 1B) of the first workpiece (e.g., first workpiece 110A of FIG. 1A) and a bonding structure (e.g., bonding structure 144B of FIG. 1B) of the second workpiece (e.g., second workpiece 110B of FIG. 1A).

In operation 908, the processor 120 of the circuit design modeling system 102 determines types (e.g., types 140 of FIG. 1B) of the plurality of contact points (e.g., contact points 138 of FIG. 1B) based on the first layout file (e.g., first layout file 130A of FIG. 1B) and the second layout file (e.g., second layout file 130B of FIG. 1B). The types (e.g., types 140 of FIG. 1B) of the plurality of contact points (e.g., contact points 138 of FIG. 1B) may include types based on dimensions, geometry, and pitch of the bonding structures, as well as dimensions and geometry of adjacent metallization features.

In operation 910, the processor 120 of the circuit design modeling system 102 groups the plurality of contact points (e.g., contact points 138 of FIG. 1B) into a plurality of bins (e.g., bins 142 of FIG. 1B). Each bin (e.g., each of bins 142 of FIG. 1B) includes a subset of the plurality of contact points (e.g., contact points 138 of FIG. 1B) having a same type (e.g., respective on types 140 of FIG. 1B).

In operation 912, the processor 120 of the circuit design modeling system 102 selects a bin (e.g., respective one of bins 142 of FIG. 1B). In operation 914, the processor 120 of the circuit design modeling system 102 simulates a contact point (e.g., respective one of contact points 138 of FIG. 1B) of the selected bin (e.g., respective one of bins 142 of FIG. 1B) using a physical model (e.g., physical model 126A of FIG. 1B) of a simulation model (e.g., simulation model 126 of FIG. 1B). The contact point (e.g., respective one of contact points 138 of FIG. 1B) comprises a first bonding structure (e.g., respective one of first bonding structures 144A of FIG. 1B) and a second bonding structure (e.g., respective one of second bonding structures 144B of FIG. 1B).

In operation 916, the processor 120 of the circuit design modeling system 102 determines whether the contact point (e.g., respective one of contact points 138 of FIG. 1B) has desired properties. In some embodiments, the processor 120 of the circuit design modeling system 102 may determine whether the contact point (e.g., respective one of contact points 138 of FIG. 1B) has one or more voids, whether the contact point (e.g., respective one of contact points 138 of FIG. 1B) has a desired resistance, and/or whether a material of the first bonding structure (e.g., respective one of first bonding structures 144A of FIG. 1B) and the second bonding structure (e.g., respective one of second bonding structures 144B of FIG. 1B) extends along an interface between the first workpiece (e.g., first workpiece 110A of FIG. 1A) and the second workpiece (e.g., second workpiece 110B of FIG. 1A).

In response to determining at operation 916 that the contact point (e.g., respective one of contact points 138 of FIG. 1B) has desired properties, method 900 proceeds to operation 918. In operation 918, the processor 120 of the circuit design modeling system 102 determines whether all bins (e.g., bins 142 of FIG. 1B) have been selected. In response to determining at operation 918 that all bins have not been selected, method 900 proceeds to operation 920. In operation 920, the processor 120 of the circuit design modeling system 102 selects a new bin (e.g., respective of bins 142 of FIG. 1B). After performing operation 920, method 900 proceeds back to operation 914.

In response to determining at operation 916 that the contact point (e.g., respective one of contact points 138 of FIG. 1B) does not have desired properties, method 900 proceeds to operation 922. In operation 922, the processor 120 of the circuit design modeling system 102 executes an AI model (e.g., AI model 126B of FIG. 1B) of the simulation model (e.g., simulation model 126 of FIG. 1B) to update a first layout (e.g., first layout 146A of FIG. 1B) of the first bonding structure (e.g., respective one of first bonding structures 144A of FIG. 1B) and a second layout (e.g., second layout 146B of FIG. 1B) of the second bonding structure (e.g., respective one of second bonding structures 144B of FIG. 1B) to determine an updated first layout (e.g., updated first layout 148A of FIG. 1B) and an updated second layout (e.g., updated second layout 148B of FIG. 1B), respectively. The updated first layout (e.g., updated first layout 148A of FIG. 1B) and the updated second layout (e.g., updated second layout 148B of FIG. 1B) defines an updated contact point.

In operation 924, the processor 120 of the circuit design modeling system 102 simulates the updated contact point using the physical model (e.g., physical model 126A of FIG. 1B) of the simulation model (e.g., simulation model 126 of FIG. 1B). In operation 926, the processor 120 of the circuit design modeling system 102 determines whether the updated contact point has the desired properties. In response to determining at operation 926 that the updated contact point has the desired properties, method 900 proceeds back to operation 918.

In response to determining at operation 926 that the updated contact point does not have the desired properties, method 900 proceeds to operation 928. In operation 928, the processor 120 of the circuit design modeling system 102 executes the AI model (e.g., AI model 126B of FIG. 1B) of the simulation model (e.g., simulation model 126 of FIG. 1B) to update process parameters (e.g., process parameters 128 of FIG. 1B) of a bonding process. In some embodiments, the processor 120 of the circuit design modeling system 102 updates a temperature of the bonding process. After performing operation 928, method 900 proceeds back to operation 912.

In response to determining at operation 918 that all bins have been selected, method 900 proceeds to operation 930. In operation 930, the processor 120 of the circuit design modeling system 102 executes the AI model (e.g., AI model 126B of FIG. 1B) of the simulation model (e.g., simulation model 126 of FIG. 1B) to update the first layout file (e.g., first layout file 130A of FIG. 1B) and the second layout file (e.g., second layout file 130B of FIG. 1B) and generate an updated first layout file (e.g., updated first layout file 150A of FIG. 1B) and an updated second layout file (e.g., updated second layout file 150B of FIG. 1B), respectively. In some embodiments, the updated first layout file (e.g., updated first layout file 150A of FIG. 1B) comprises updated first layouts (e.g., updated first layouts 148A of FIG. 1B) of the first bonding structures (e.g., first bonding structures 144A of FIG. 1B) and the updated second layout file (e.g., updated second layout file 150B of FIG. 1B) comprises updated second layouts (e.g., updated second layouts 148B of FIG. 1B) of the second bonding structures (e.g., second bonding structures 144B of FIG. 1B).

In operation 932, the processor 120 of the circuit design modeling system 102 sends the updated first layout file (e.g., updated first layout file 150A of FIG. 1B) to a manufacturer of the first workpiece (e.g., first workpiece 110A of FIG. 1A) and the updated second layout file (e.g., updated second layout file 150B of FIG. 1B) to a manufacturer of the second workpiece (e.g., second workpiece 110B of FIG. 1A). In operation 934, the processor 120 of the circuit design modeling system 102 sends the updated process parameters (e.g., updated process parameters 152 of FIG. 1B) to the bonding apparatus (e.g., bonding apparatus 100 of FIG. 1A).

In operation 936, the processor 120 of the circuit design modeling system 102 receives test results (e.g., test results 154 of FIG. 1B) obtained by testing a test chip. In some embodiments, the test chip may comprise one or more updated contact points. In operation 938, the processor 120 of the circuit design modeling system 102 updates the simulation model (e.g., simulation model 126 of FIG. 1B) based on the test results to generate an updated simulation model (e.g., updated simulation model 156 of FIG. 1B). In some embodiments, the processor 120 of the circuit design modeling system 102 updates the physical model (e.g., physical model 126A of FIG. 1B) and/or the AI model (e.g., AI model 126B of FIG. 1B) of the simulation model (e.g., simulation model 126 of FIG. 1B).

FIGS. 10A and 10B illustrate a process flow diagram of a method 1000 for bonding workpieces in accordance with various embodiments. The method 1000 may be implemented, at least in part, in the form of executable code (e.g., software instructions 124 and simulation model 126) stored on non-transitory, tangible, computer-readable medium (e.g., memory 122) that when executed by one or more processors (e.g., processor 120) may cause the one or more processors to perform one or more of the operations 1002-1032.

Method 1000 starts with operation 1002. In operation 1002, a processor 120 of the circuit design modeling system 102 (see FIG. 1B) receives a notification (e.g., notification 158 of FIG. 1B) from a bonding apparatus (e.g., bonding apparatus 100 of FIG. 1A) that a first workpiece (e.g., first workpiece 110A of FIG. 1A) and a second workpiece (e.g., second workpiece 110B of FIG. 1A) are to be bonded. In operation 1004, the processor 120 of the circuit design modeling system 102 (see FIG. 1B) receives a first layout file (e.g., first layout file 130A of FIG. 1B), first design rules (e.g., first design rules 132A of FIG. 1B), first parameter variations (e.g., first parameter variations 134A of FIG. 1B), and first material parameters (e.g., first material parameters 136A of FIG. 1B) for a first workpiece (e.g., first workpiece 110A of FIG. 1A). In operation 1006, the processor 120 of the circuit design modeling system 102 receives a second layout file (e.g., second layout file 130B of FIG. 1B), second design rules (e.g., second design rules 132B of FIG. 1B), second parameter variations (e.g., second parameter variations 134B of FIG. 1B), and second material parameters (e.g., second material parameters 136B of FIG. 1B) for a second workpiece (e.g., second workpiece 110B of FIG. 1A). In operation 1008, the processor 120 of the circuit design modeling system 102 receives process parameters (e.g., process parameters 128 of FIG. 1B) of a bonding process to be performed by the bonding apparatus (e.g., bonding apparatus 100 of FIG. 1A).

In operation 1010, the processor 120 of the circuit design modeling system 102 analysis the first layout file (e.g., first layout file 130A of FIG. 1B) and the second layout file (e.g., second layout file 130B of FIG. 1B) to identify a plurality of contact points (e.g., contact points 138 of FIG. 1B). Each contact point (e.g., each of contact points 138 of FIG. 1B) comprises a bonding structure (e.g., bonding structure 144A of FIG. 1B) of the first workpiece (e.g., first workpiece 110A of FIG. 1A) and a bonding structure (e.g., bonding structure 144B of FIG. 1B) of the second workpiece (e.g., second workpiece 110B of FIG. 1A).

In operation 1012, the processor 120 of the circuit design modeling system 102 determines types (e.g., types 140 of FIG. 1B) of the plurality of contact points (e.g., contact points 138 of FIG. 1B) based on the first layout file (e.g., first layout file 130A of FIG. 1B) and the second layout file (e.g., second layout file 130B of FIG. 1B). The types (e.g., types 140 of FIG. 1B) of the plurality of contact points (e.g., contact points 138 of FIG. 1B) may include types based on dimensions, geometry, and pitch of the bonding structures, as well as dimensions and geometry of adjacent metallization features.

In operation 1014, the processor 120 of the circuit design modeling system 102 groups the plurality of contact points (e.g., contact points 138 of FIG. 1B) into a plurality of bins (e.g., bins 142 of FIG. 1B). Each bin (e.g., each of bins 142 of FIG. 1B) includes a subset of the plurality of contact points (e.g., contact points 138 of FIG. 1B) having a same type (e.g., respective on types 140 of FIG. 1B).

In operation 1016, the processor 120 of the circuit design modeling system 102 selects a bin (e.g., respective one of bins 142 of FIG. 1B). In operation 1018, the processor 120 of the circuit design modeling system 102 simulates a contact point (e.g., respective one of contact points 138 of FIG. 1B) of the selected bin (e.g., respective one of bins 142 of FIG. 1B) using a physical model (e.g., physical model 126A of FIG. 1B) of a simulation model (e.g., simulation model 126 of FIG. 1B). The contact point (e.g., respective one of contact points 138 of FIG. 1B) comprises a first bonding structure (e.g., respective one of first bonding structures 144A of FIG. 1B) and a second bonding structure (e.g., respective one of second bonding structures 144B of FIG. 1B).

In operation 1020, the processor 120 of the circuit design modeling system 102 determines whether the contact point (e.g., respective one of contact points 138 of FIG. 1B) has desired properties. In some embodiments, the processor 120 of the circuit design modeling system 102 may determine whether the contact point (e.g., respective one of contact points 138 of FIG. 1B) has one or more voids, whether the contact point (e.g., respective one of contact points 138 of FIG. 1B) has a desired resistance, and/or whether a material of the first bonding structure (e.g., respective one of first bonding structures 144A of FIG. 1B) and the second bonding structure (e.g., respective one of second bonding structures 144B of FIG. 1B) extends along an interface between the first workpiece (e.g., first workpiece 110A of FIG. 1A) and the second workpiece (e.g., second workpiece 110B of FIG. 1A).

In response to determining at operation 1020 that the contact point (e.g., respective one of contact points 138 of FIG. 1B) has desired properties, method 1000 proceeds to operation 1022. In operation 1022, the processor 120 of the circuit design modeling system 102 determines whether all bins (e.g., bins 142 of FIG. 1B) have been selected. In response to determining at operation 1022 that all bins have not been selected, method 1000 proceeds to operation 1024. In operation 1024, the processor 120 of the circuit design modeling system 102 selects a new bin (e.g., respective of bins 142 of FIG. 1B). After performing operation 1024, method 1000 proceeds back to operation 2018.

In response to determining at operation 1020 that the contact point (e.g., respective one of contact points 138 of FIG. 1B) does not have desired properties, method 1000 proceeds to operation 1026. In operation 1026, the processor 120 of the circuit design modeling system 102 updates process parameters (e.g., process parameters 128 of FIG. 1B) of the bonding process to determine updated process parameters (e.g., updated process parameters 152 of FIG. 1B). After performing operation 1026, method 1000 proceeds back to operation 1016.

In response to determining at operation 1022 that all bins have been selected, method 1000 proceeds to operation 1028. In operation 1028, the processor 120 of the circuit design modeling system 102 determines whether the process parameters (e.g., process parameters 128 of FIG. 1B) have been updated. In response to determining at operation 1028 that the process parameters (e.g., process parameters 128 of FIG. 1B) have been updated, method 1000 proceeds to operation 1030. In operation 1030, the processor 120 of the circuit design modeling system 102 sends the updated process parameters (e.g., updated process parameters 152 of FIG. 1B) of the bonding process to the bonding apparatus (e.g., bonding apparatus of FIG. 1A).

In response to determining at operation 1028 that the process parameters (e.g., process parameters 128 of FIG. 1B) have not been updated or after performing operation 1030, method 1000 proceeds to operation 1032. In operation 1032, the processor 120 of the circuit design modeling system 102 sends an instruction (e.g., instruction 160 of FIG. 1B) to the bonding apparatus (e.g., bonding apparatus of FIG. 1A) to perform the bonding process between the first workpiece (e.g., first workpiece 110A of FIG. 1A) and the second workpiece (e.g., second workpiece 110B of FIG. 1A). After performing operation 1032, method 1000 proceeds to end. Upon receiving the instruction (e.g., instruction 160 of FIG. 1B), the bonding apparatus (e.g., bonding apparatus of FIG. 1A) performs the bonding process between the first workpiece (e.g., first workpiece 110A of FIG. 1A) and the second workpiece (e.g., second workpiece 110B of FIG. 1A).

Example embodiments of the disclosure are described below. Other embodiments can also be understood from the entirety of the specification as well as the claims filed herein.

Example 1. An apparatus includes a memory configured to store a simulation model and process parameters of a bonding process. The apparatus further includes a processor communicatively coupled to the memory. The processor is configured to receive a first layout file, first design rules, first parameter variations, and first material parameters for a first workpiece. The processor is further configured to receive a second layout file, second design rules, second parameter variations, and second material parameters for a second workpiece. The processor is further configured to analyze the first layout file and the second layout file to identify a plurality of contact points. Each contact point includes a feature of the first workpiece and a feature of the second workpiece. The processor is further configured to determine types of the plurality of contact points based on the first layout file and the second layout file and group the plurality of contact points into a plurality of bins. Each bin includes a subset of the plurality of contact points having a same type. The processor is further configured to simulate a first contact point of a first bin of the plurality of bins using the simulation model. The first contact point includes a first feature of the first workpiece and a second feature of the second workpiece. The processor is further configured to determine whether the first contact point has desired properties and, in response to determining that the first contact point does not have the desired properties update a first layout of the first feature and a second layout of the second feature to determine an updated first contact point, simulate the updated first contact point using the simulation model, and determine whether the updated first contact point has the desired properties. In response to determining that the updated first contact point has the desired properties, the processor is further configured to update the first layout file to include the updated first layout of the first feature and update the second layout file to include the updated second layout of the second feature.

Example 2. The apparatus of example 1, where the processor is further configured to, in response to determining that the updated first contact point does not have the desired properties, update the process parameters of the bonding process.

Example 3. The apparatus of one of examples 1 and 2, where the processor is further configured to send the updated process parameters of the bonding process to a bonding apparatus.

Example 4. The apparatus of one of examples 1 to 3, where the processor is further configured to receive test results, the test results being obtained from testing a test chip including the updated first contact point, and update the simulation model based on the test results.

Example 5. The apparatus of one of examples 1 to 4, where the processor is further configured to, in response to determining that the updated first contact point has the desired properties simulate a second contact point of a second bin of the plurality of bins using the simulation model. The second contact point includes a third feature of the first workpiece and a fourth feature of the second workpiece. The processor is further configured to determine whether the second contact point has desired properties. In response to determining that the second contact point does not have the desired properties, the processor is further configured to update a third layout of the third feature and a fourth layout of the fourth feature to determine an updated second contact point, simulate the updated second contact point using the simulation model, and determine whether the updated second contact point has the desired properties. In response to determining that the updated second contact point has the desired properties, the processor is further configured to update the first layout file to include the updated third layout of the third feature and update the second layout file to include the updated fourth layout of the fourth feature.

Example 6. The apparatus of one of examples 1 to 5, where the first contact point and the second contact point are simulated in parallel.

Example 7. The apparatus of one of examples 1 to 6, where the simulation model simulates the bonding process between the first workpiece and the second workpiece.

Example 8. A method includes receiving a first layout file, first design rules, first parameter variations, and first material parameters for a first workpiece, and receiving a second layout file, second design rules, second parameter variations, and second material parameters for a second workpiece. The method further includes analyzing the first layout file and the second layout file to identify a plurality of contact points. Each contact point includes a feature of the first workpiece and a feature of the second workpiece. The method further includes determining types of the plurality of contact points based on the first layout file and the second layout file and grouping the plurality of contact points into a plurality of bins. Each bin includes a subset of the plurality of contact points having a same type. The method further includes simulating a first contact point of a first bin of the plurality of bins using a simulation model. The first contact point includes a first feature of the first workpiece and a second feature of the second workpiece. The method further includes determining whether the first contact point has desired properties. In response to determining that the first contact point does not have the desired properties, the method further includes updating a first layout of the first feature and a second layout of the second feature to determine an updated first contact point, simulating the updated first contact point using the simulation model, and determining whether the updated first contact point has the desired properties. In response to determining that the updated first contact point has the desired properties, the method further includes updating the first layout file to include the updated first layout of the first feature and updating the second layout file to include the updated second layout of the second feature.

Example 9. The method of example 8, further including, in response to determining that the updated first contact point does not have the desired properties, updating process parameters of a bonding process.

Example 10. The method of one of examples 8 and 9, further including sending the updated process parameters of the bonding process to a bonding apparatus.

Example 11. The method of one of examples 8 to 10, further including receiving test results, the test results being obtained from testing a test chip including the updated first contact point, and updating the simulation model based on the test results.

Example 12. The method of one of examples 8 to 11, further including, in response to determining that the updated first contact point has the desired properties simulating a second contact point of a second bin of the plurality of bins using the simulation model. The second contact point includes a third feature of the first workpiece and a fourth feature of the second workpiece. The method further includes determining whether the second contact point has desired properties. In response to determining that the second contact point does not have the desired properties, the method further includes updating a third layout of the third feature and a fourth layout of the fourth feature to determine an updated second contact point, simulating the updated second contact point using the simulation model, and determining whether the updated second contact point has the desired properties. In response to determining that the updated second contact point has the desired properties, the method further includes updating the first layout file to include the updated third layout of the third feature and updating the second layout file to include the updated fourth layout of the fourth feature.

Example 13. The method of one of examples 8 to 12, where the first contact point and the second contact point are simulated in parallel.

Example 14. The method of one of examples 8 to 13, where the simulation model simulates a bonding process between the first workpiece and the second workpiece.

Example 15. A non-transitory computer-readable medium storing instructions that, when executed by one or more processors, cause the one or more processors to receive a first layout file, first design rules, first parameter variations, and first material parameters for a first workpiece, and receive a second layout file, second design rules, second parameter variations, and second material parameters for a second workpiece. The instructions, when executed by one or more processors, further cause the one or more processors to analyze the first layout file and the second layout file to identify a plurality of contact points. Each contact point includes a feature of the first workpiece and a feature of the second workpiece. The instructions, when executed by one or more processors, further cause the one or more processors to determine types of the plurality of contact points based on the first layout file and the second layout file, group the plurality of contact points into a plurality of bins, wherein each bin includes a subset of the plurality of contact points having a same type, and simulate a first contact point of a first bin of the plurality of bins using a simulation model. The first contact point includes a first feature of the first workpiece and a second feature of the second workpiece. The instructions, when executed by one or more processors, further cause the one or more processors to determine whether the first contact point has desired properties. In response to determining that the first contact point does not have the desired properties, the instructions, when executed by one or more processors, further cause the one or more processors to update a first layout of the first feature and a second layout of the second feature to determine an updated first contact point, simulate the updated first contact point using the simulation model, and determine whether the updated first contact point has the desired properties. In response to determining that the updated first contact point has the desired properties, the instructions, when executed by one or more processors, further cause the one or more processors to update the first layout file to include the updated first layout of the first feature and update the second layout file to include the updated second layout of the second feature.

Example 16. The non-transitory computer-readable medium of example 15, where the instructions, when executed by the one or more processors, further cause the one or more processors to, in response to determining that the updated first contact point does not have the desired properties, update process parameters of a bonding process.

Example 17. The non-transitory computer-readable medium of one of examples 15 and 16, where the instructions, when executed by the one or more processors, further cause the one or more processors to send the updated process parameters of the bonding process to a bonding apparatus.

Example 18. The non-transitory computer-readable medium of one of examples 15 to 17, where the instructions, when executed by the one or more processors, further cause the one or more processors to receive test results, the test results being obtained from testing a test chip including the updated first contact point, and update the simulation model based on the test results.

Example 19. The non-transitory computer-readable medium of one of examples 15 to 18, where the instructions, when executed by the one or more processors, further cause the one or more processors to, in response to determining that the updated first contact point has the desired properties simulate a second contact point of a second bin of the plurality of bins using the simulation model. The second contact point includes a third feature of the first workpiece and a fourth feature of the second workpiece. The instructions, when executed by the one or more processors, further cause the one or more processors to determine whether the second contact point has desired properties. In response to determining that the second contact point does not have the desired properties, the instructions, when executed by the one or more processors, further cause the one or more processors to update a third layout of the third feature and a fourth layout of the fourth feature to determine an updated second contact point, simulate the updated second contact point using the simulation model, and determine whether the updated second contact point has the desired properties. In response to determining that the updated second contact point has the desired properties, the instructions, when executed by the one or more processors, further cause the one or more processors to update the first layout file to include the updated third layout of the third feature and update the second layout file to include the updated fourth layout of the fourth feature.

Example 20. The non-transitory computer-readable medium of one of examples 15 to 19, where the first contact point and the second contact point are simulated in parallel.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A system comprising:
a memory configured to store:
a simulation model; and
process parameters of a bonding process; and
a processor communicatively coupled to the memory, wherein the processor is configured to:
receive a first layout file, first design rules, first parameter variations, and first material parameters for a first workpiece;
receive a second layout file, second design rules, second parameter variations, and second material parameters for a second workpiece;
analyze the first layout file and the second layout file to identify a plurality of contact points, wherein each contact point comprises a feature of the first workpiece and a feature of the second workpiece;
determine types of the plurality of contact points based on the first layout file and the second layout file;
group the plurality of contact points into a plurality of bins, wherein each bin includes a subset of the plurality of contact points having a same type;
simulate a first contact point of a first bin of the plurality of bins using the simulation model, wherein the first contact point comprises a first feature of the first workpiece and a second feature of the second workpiece;
determine whether the first contact point has desired properties; and
in response to determining that the first contact point does not have the desired properties:
update a first layout of the first feature and a second layout of the second feature to determine an updated first contact point;
simulate the updated first contact point using the simulation model;
determine whether the updated first contact point has the desired properties; and
in response to determining that the updated first contact point has the desired properties:
update the first layout file to include the updated first layout of the first feature; and
update the second layout file to include the updated second layout of the second feature.

2. The system of claim 1, wherein the processor is further configured to, in response to determining that the updated first contact point does not have the desired properties, update the process parameters of the bonding process.

3. The system of claim 2, wherein the processor is further configured to send the updated process parameters of the bonding process to a bonding apparatus.

4. The system of claim 1, wherein the processor is further configured to:
receive test results, the test results being obtained from testing a test chip comprising the updated first contact point; and
update the simulation model based on the test results.

5. The system of claim 1, wherein the processor is further configured to, in response to determining that the updated first contact point has the desired properties:
simulate a second contact point of a second bin of the plurality of bins using the simulation model, wherein the second contact point comprises a third feature of the first workpiece and a fourth feature of the second workpiece;
determine whether the second contact point has desired properties; and
in response to determining that the second contact point does not have the desired properties:
update a third layout of the third feature and a fourth layout of the fourth feature to determine an updated second contact point;
simulate the updated second contact point using the simulation model;
determine whether the updated second contact point has the desired properties; and
in response to determining that the updated second contact point has the desired properties:
update the first layout file to include the updated third layout of the third feature; and
update the second layout file to include the updated fourth layout of the fourth feature.

6. The system of claim 5, wherein the first contact point and the second contact point are simulated in parallel.

7. The system of claim 1, wherein the simulation model simulates the bonding process between the first workpiece and the second workpiece.

8. A method comprising:
receiving a first layout file, first design rules, first parameter variations, and first material parameters for a first workpiece;
receiving a second layout file, second design rules, second parameter variations, and second material parameters for a second workpiece;
analyzing the first layout file and the second layout file to identify a plurality of contact points, wherein each contact point comprises a feature of the first workpiece and a feature of the second workpiece;
determining types of the plurality of contact points based on the first layout file and the second layout file;
grouping the plurality of contact points into a plurality of bins, wherein each bin includes a subset of the plurality of contact points having a same type;
simulating a first contact point of a first bin of the plurality of bins using a simulation model, wherein the first contact point comprises a first feature of the first workpiece and a second feature of the second workpiece;
determining whether the first contact point has desired properties; and
in response to determining that the first contact point does not have the desired properties:
updating a first layout of the first feature and a second layout of the second feature to determine an updated first contact point;
simulating the updated first contact point using the simulation model;
determining whether the updated first contact point has the desired properties; and
in response to determining that the updated first contact point has the desired properties:
updating the first layout file to include the updated first layout of the first feature; and
updating the second layout file to include the updated second layout of the second feature.

9. The method of claim 8, further comprising, in response to determining that the updated first contact point does not have the desired properties, updating process parameters of a bonding process.

10. The method of claim 9, further comprising sending the updated process parameters of the bonding process to a bonding apparatus.

11. The method of claim 8, further comprising:
receiving test results, the test results being obtained from testing a test chip comprising the updated first contact point; and
updating the simulation model based on the test results.

12. The method of claim 8, further comprising, in response to determining that the updated first contact point has the desired properties:
simulating a second contact point of a second bin of the plurality of bins using the simulation model, wherein the second contact point comprises a third feature of the first workpiece and a fourth feature of the second workpiece;
determining whether the second contact point has desired properties; and
in response to determining that the second contact point does not have the desired properties:
updating a third layout of the third feature and a fourth layout of the fourth feature to determine an updated second contact point;
simulating the updated second contact point using the simulation model;
determining whether the updated second contact point has the desired properties; and
in response to determining that the updated second contact point has the desired properties:
updating the first layout file to include the updated third layout of the third feature; and
updating the second layout file to include the updated fourth layout of the fourth feature.

13. The method of claim 12, wherein the first contact point and the second contact point are simulated in parallel.

14. The method of claim 8, wherein the simulation model simulates a bonding process between the first workpiece and the second workpiece.

15. A non-transitory computer-readable medium storing instructions that, when executed by one or more processors, cause the one or more processors to:
receive a first layout file, first design rules, first parameter variations, and first material parameters for a first workpiece;
receive a second layout file, second design rules, second parameter variations, and second material parameters for a second workpiece;
analyze the first layout file and the second layout file to identify a plurality of contact points, wherein each contact point comprises a feature of the first workpiece and a feature of the second workpiece;
determine types of the plurality of contact points based on the first layout file and the second layout file;
group the plurality of contact points into a plurality of bins, wherein each bin includes a subset of the plurality of contact points having a same type;
simulate a first contact point of a first bin of the plurality of bins using a simulation model, wherein the first contact point comprises a first feature of the first workpiece and a second feature of the second workpiece;
determine whether the first contact point has desired properties; and
in response to determining that the first contact point does not have the desired properties:
update a first layout of the first feature and a second layout of the second feature to determine an updated first contact point;
simulate the updated first contact point using the simulation model;
determine whether the updated first contact point has the desired properties; and
in response to determining that the updated first contact point has the desired properties:
update the first layout file to include the updated first layout of the first feature; and
update the second layout file to include the updated second layout of the second feature.

16. The non-transitory computer-readable medium of claim 15, wherein the instructions, when executed by the one or more processors, further cause the one or more processors to, in response to determining that the updated first contact point does not have the desired properties, update process parameters of a bonding process.

17. The non-transitory computer-readable medium of claim 16, wherein the instructions, when executed by the one or more processors, further cause the one or more processors to send the updated process parameters of the bonding process to a bonding apparatus.

18. The non-transitory computer-readable medium of claim 15, wherein the instructions, when executed by the one or more processors, further cause the one or more processors to:
receive test results, the test results being obtained from testing a test chip comprising the updated first contact point; and
update the simulation model based on the test results.

19. The non-transitory computer-readable medium of claim 15, wherein the instructions, when executed by the one or more processors, further cause the one or more processors to, in response to determining that the updated first contact point has the desired properties:
simulate a second contact point of a second bin of the plurality of bins using the simulation model, wherein the second contact point comprises a third feature of the first workpiece and a fourth feature of the second workpiece;
determine whether the second contact point has desired properties; and
in response to determining that the second contact point does not have the desired properties:
update a third layout of the third feature and a fourth layout of the fourth feature to determine an updated second contact point;
simulate the updated second contact point using the simulation model;
determine whether the updated second contact point has the desired properties; and
in response to determining that the updated second contact point has the desired properties:
update the first layout file to include the updated third layout of the third feature; and
update the second layout file to include the updated fourth layout of the fourth feature.

20. The non-transitory computer-readable medium of claim 19, wherein the first contact point and the second contact point are simulated in parallel.
